(19) United States
(12) Patent Application Publication
(10) Pub. No.: US 2022/0401310 A1
(43) Pub. Date: Dec. 22, 2022

(54) Enteral Nutrition Gastronomy Access Device

(71) Applicant: Luminoah, Inc., Charlottesville, VA (US)

(72) Inventors: Joseph Neal Piper, Charlottesville, VA (US); Hill Johnson, Charlottesville, VA (US); Jonathan Jay Rosen, Charlottesville, VA (US); Ethan Creasman, Youngsville, NC (US); Brian Himelright, Raleigh, NC (US); Ty Hagler, Chapel Hill, NC (US)

(21) Appl. No.: 17/843,397

(22) Filed: Jun. 17, 2022

Related U.S. Application Data
(60) Provisional application No. 63/211,618, filed on Jun. 17, 2021.

(51) Int. Cl. A61J 15/00

(52) U.S. Cl. CPC A61J 15/0019; A61J 15/0042; A61J 15/0053

(57) ABSTRACT

The present invention is an enteral nutrition gastrostomy access device. A permanent or semi-permanent stoma liner is adjustably positioned within a stoma channel extending through a patient's abdominal and stomach walls. The stoma liner is characterized by an adjustable bladder capable of applying variable torsional force to one or more pinch points along the interface between the stoma liner and the stoma. The stoma liner is configured to receive a plug with a central threaded channel, into which a cap or enteral feeding device may be wholly or partially inserted. The central threaded channel is characterized by requiring application of a linear push force to apply but requiring application of both a linear pull force and a torsional force to remove.

### CLAIM TO PRIORITY

This application claims under 35 U.S.C. § 120, the benefit of the Application 63/211,618, filed Jun. 17, 2021, titled “Enteral Nutrition Gastronomy Access Device” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Medical patients for whom oral feeding is not allowable or sufficient commonly benefit from prescribed enteral nutrition. This form of therapy delivers nutrition directly to a patient's gastrointestinal tract (GI) through man-made tubes that are placed into the GI tract. In order to access any portion of the patient's GI tract, the placed tubes must enter the patient's body through incisions created in the patient's abdominal wall or through existing body cavities such as the nasal cavity.

The distal end of any such tube is placed in the GI tract, while the proximal end of any such tube remains outside of the patient's body, permitting the proximal end to interface with enteral nutrition delivery technology. Surgically implanted tubes are generally indicated for long-term enteral nutrition needs while nasally placed tubes are indicated for short-term (less than two months) needs or when a patient is not healthy enough to tolerate surgery. Commonly, gastrostomy tubes are placed one of three ways: (1) surgically, through an open procedure or laparoscopically, (2) endoscopically, or (3) radiologically with a percutaneous insertion procedure.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1A is a first view of the device in-situ within a patient consistent with certain embodiments of the present invention.

FIG. 1B is a second view of the device in-situ within a patient consistent with certain embodiments of the present invention.

FIG. 2 is a first cross-sectional view of the in-situ device consistent with certain embodiments of the present invention.

FIG. 3 is a second cross-sectional view of the in-situ device consistent with certain embodiments of the present invention.

FIG. 4 is a stylized orthogonal view of a stand-alone Stoma Liner Grommet consistent with certain embodiments of the present invention.

FIG. 5 is a cross-sectional view of Safety Release Points that permit the device to disassemble under a certain threshold force consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Current gastronomy access devices have been designed to permit Percutaneous Insertion, with the devices being very easily placed and/or replaced in individuals that have a mature stoma tract. A stoma is an artificial channel made into a hollow organ, with the stoma tract being the assemblage of tissues lining the stoma and leading into the hollow organ. Typically, a mature stoma tract is present in patients more than 2-weeks after an operation in which the stoma is created. Percutaneous Insertion Devices and associated Systems are lubricated, slid into the stoma, and then inflated with saline to secure the device. Such devices are characterized by their adaptability. In a non-limiting example, from both a patient's and a practitioner's viewpoint it is valuable that the commonly used saline balloon provides the ability to adjust and tighten the fit of an enteral feeding device. This ability is present for patients exhibiting a wide array of various medical factors or physiological changes. It is important for patients, practitioners and caregivers to be able to maintain the device's accurate fit within the patient's stoma, whether it needs to be tightened or loosened for any reason.

Despite the evidence of such benefits, state of the art devices nevertheless rely upon the problematic low-profile gastrostomy tube. These devices are commonly anchored to the inside of a patient's stomach using a balloon filled with two to five milliliters of saline, thereby creating an internal bolster that prevents the movement of the device in or out of the stoma. As the bolster sits within the stoma, it may present a variety of common medical issues such as the development of Granulation Tissue, Stoma Infection, Gastric Leakage, and GI Blockage, as well as potential Dislodgment of the device.

Development of Granulation Tissue is characterized by the accumulation of hard, dry skin around the stoma and inserted tube. These accumulations can make using any attached Access Device, such as an Enteral Delivery Device, painful and can become infected much easier than healthy skin. Stoma Infection can occur due to the nature of an Enteral Delivery Device interfacing directly with an “open” portion of the body. Because the positioning of such devices requires human hands to manipulate the device frequently, such manipulation often creates opportunity for bacteria to accumulate and precipitate infection. Such manipulation can also contribute to Gastric Leakage, a phenomenon characterized by the seeping of stomach or other GI fluid onto skin or other tissues not resistant to the corrosive effects of acidic GI compounds. Gastric Leakage often occurs due to the presence of an imperfect seal from the Enteral Delivery Device to the stoma. As a result of such imperfect seal, human movement and/or gas buildup may cause stomach contents, including acids, to leak around the Access Device and painfully damage the skin area. It is important to note that an imperfect seal is elusive even with conscientious application, for if the bolster or anchor is secured too tightly, it will begin to erode the patient's skin and thereby create an ulcer, ultimately leading to additional complications that may be more serious and more difficult to remedy.

GI Blockage occurs due to the particular geometric configuration of an inserted saline balloon bolster, which may be too large for a particular patient's anatomy. As there is a limited amount of space inside a stomach, the balloon bolster, which acts as an anchor, sometimes occupies too much volume. In such case the balloon bolster can block the pyloric sphincter and affect GI motility. In the event that an inserted saline balloon weakens or degrades, a patient may experience Dislodgment of the balloon anchor. Such Dislodgment is not merely an inconvenience; while it can undeniably be messy and uncomfortable, Dislodgment without timely remedy makes the patient's stoma susceptible to closing and healing over. Consequently, accidental Dislodgment can demand swift action by caregivers and/or patients to immediately re-insert the device and thereby avert the need for subsequent invasive procedures or surgery. While Dislodgment can occur at any point after insertion, it can be much more harmful when it occurs within two weeks of surgical placement. Accidental Dislodgement may occur when a parent or caregiver is picking up a child and a feeding tube and/or an Access Device gets caught on clothing, furniture, or appendages and is pulled out of its place. Accidental Dislodgement may also occur when a child or infant kicks during a feeding action, when a cognitively, behaviorally, or emotionally impaired patient innocently pulls at the device, or as the result of other unforeseen actions.

There is a need for an enteral nutrition gastrostomy Access Device which while permitting easy insertion, adaptively avoids the stated shortcomings. The instant innovation utilizes a series of features to accomplish these goals.

In an embodiment, the instant innovation uses a Stoma Liner to serve as a type of “grommet” which creates a more fluid-tight seal against the surrounding human tissue. The resulting seal serves to limit Gastric Leakage, to act as the primary anchor and to prevent GI Blockage. The Stoma Liner is constructed of antimicrobial material to limit infection and the development of Granulation Tissue, and in an embodiment plays a central role in supporting and providing integrated Safety Release Points. In an embodiment, the Stoma Liner provides for a longer in-situ lifespan than the associated feeding device, permitting leaving the Stoma Liner in place through multiple feeding device changes. The Stoma Liner may incorporate a sewing ring for external connection and sealing purposes, among others. Once a caregiver is provided a permanent or semi-permanent channel through which materiel may be introduced or removed past the abdominal wall, targeted application of medically necessary materiel may be made to any portion of the patient's GI tract through varying the length and/or placement of one or more feeding tubes.

In an embodiment, the instant innovation incorporates one or more Safety Release Points designed to mitigate the incidence of accidental Dislodgement in the patient population. These Safety Release Points permit the device to disassemble under a certain threshold force in order to prevent the patient from pulling the entire device from the stoma. The Safety Release Points are in an embodiment triggered from the inside threads of the access device. Through this design, the only way for the system to disassemble is from uncommon use of excess force from the tube being pulled, preventing disassembly during routine insertion, cleaning, maintenance, and/or other manipulation.

In an embodiment, the instant innovation utilizes an Accessible Streamlined Attachment for the connection of enteral tubing to flow nutrition into patient. This Accessible Streamlined Attachment connects the enteral tubing to an Access Device while adhering to the ISO 80369 standard. This Accessible Streamlined Attachment also allows the connection of enteral tubing to the Stoma Liner by simply pushing a Connector into the Access Device lumen. In this context, a lumen is a cavity or channel within a tube or tubular organ. In order to remove the Connector however, a user must apply a twisting motion associated with threaded connections to disconnect. In a non-limiting example, a caregiver may have to produce a twist up to about 270 degrees to align the threaded connections to perform the disconnection of the Connector from the Access Device lumen.

In an embodiment the instant innovation may be used as part of a proprietary feeding delivery system with enhanced capabilities such as, by way of non-limiting example, improved visual indicators and monitoring. Such a system facilitates patient data collection and instrumentation of the device in numerous non-limiting ways.

In an embodiment, such system permits volume and/or rate tracking and verification for empirical study and/or to confirm pump sensor readings for total system performance. The system permits occlusion detection within the access device, providing data separate from pump system occlusion detection and applicable for users that are non-pump feeders. In an embodiment the device may incorporate fiber optics for rapid transmission of information, one or more optical sensors for recognizing sediment, biafilm, and residue buildup in the lumen of the device, and/or one or more sensors for attachment recognition to provide, among other non-limiting functions, automatic feed initiation upon connection, automatic feed cessation upon disconnection, and/or altered flow rate making possible initial rapid priming and then switching to a patient-specific low flow rate.

In an embodiment the system described herein permits remote sensing with fiber optics or related technology. In such embodiment the transmitter and receiver may be separated by a light conducting conduit or other means.

In an embodiment the system utilizes visual indicators and a related user interface incorporating both light indicators visible through an external bolster and color changing Stoma Liner materials. Such color change can be used to indicate the presence of inflammation or an infectious event, or the presence of Gastric Leakage. In an embodiment a. light pipe and/or fiber optic design is relied upon to send light signals to a Personal Alert Safety System device, and back.

In an embodiment, the instant innovation offers the convenience of instant pump priming. Due to the device pump's immersion in a fluid feed, a user may prime the pump of the instant innovation while the feeding device is connected to a patient. This one-step process provides convenience and removes user error from a device requiring pump priming prior to device connection to a patient.

In an embodiment, device attachment between the Stoma Liner and the Patient is enhanced by use of Stoma Liners fitted in multiple sizes from 8 Fr-26 Fr, with adaptable configurations to make a tight seal. Each Stoma Liner has one or more low profile inner and outer bladders that can be inflated if the device fit needs further securement. Device attachment between the Stoma Liner and the Access Device, such as an Enteral Feeding Device, is enhanced by use of the bladders on the interior lumen of the Stoma Liner device that can be inflated and/or deflated to grip a variety of pinch points along the Access Device. In such embodiment, the Stoma Liner bladders have rigid tips that engage “female” attachment points on the stem of the Access Device. These female attachment points are characterized by slight rigid indentation to “accept” the tips or ridges located on the Stoma Liner bladders. The Access Device has a slightly flared bottom for extra attachment security.

In an embodiment, the instant innovation incorporates a super-hydrophobic inner coating to limit the build-up of formula, medication, particulate, or other extraneous material. Such coating reduces the frequency with which the device cavities need be flushed with water. The device incorporates outer coatings suitable to enhance cleanliness and long-life, such as, by way of non-limiting example, those with silver nitrate, chlorhexidine silver, and/or licensed BlueGuard technology.

In an embodiment, the instant innovation may be introduced to a patient by one or more procedures replacing typical surgical, endoscopic, or radiological procedures. Such one or more procedures benefit from the availability of a handheld surgical instrument that is preloaded with sutures or staples and used to secure a primary device (PASS) in-situ, adhering the stomach lining and abdominal wall in the process. Such instrument deploys the necessary suture and/or staple arrangement to secure the device in-situ with one trigger pull. Once the device is securely attached to the patient, the procedure can be concluded with necessary following steps such as, by way of non-limiting example, application of bandages or disinfectant or device operational testing.

in an embodiment, the instant innovation may be utilized to facilitate other cross-tissue or cross-membrane fluid transfer such as acting as, by way of non-limiting example, a Central Line Access Portal for long term access for infusions; enabling Dialysis through shunt placement, fistula formation, central line dialysis, and/or peritoneal dialysis; enabling Chemotherapy as a hyperport access; acting as a Hydrocephalus shunt; and permitting Colostomy applications, including ostomy implant, among many other possible applications.

In an embodiment, the instant innovation may be used in veterinary medical applications to a similar or greater extent than that to which it is used in human applications. Indeed, the instant innovation may be used in any medical or non-medical application requiring penetration and throughput of a flexible membrane or tissue, securely attaching to the interior of the flexible membrane and providing a secure port or opening into that flexible membrane to which other tubes, tools, or materials may be attached to introduce solid, fluid, or viscous compositions of matter into the flexible membrane on a repeatable basis.

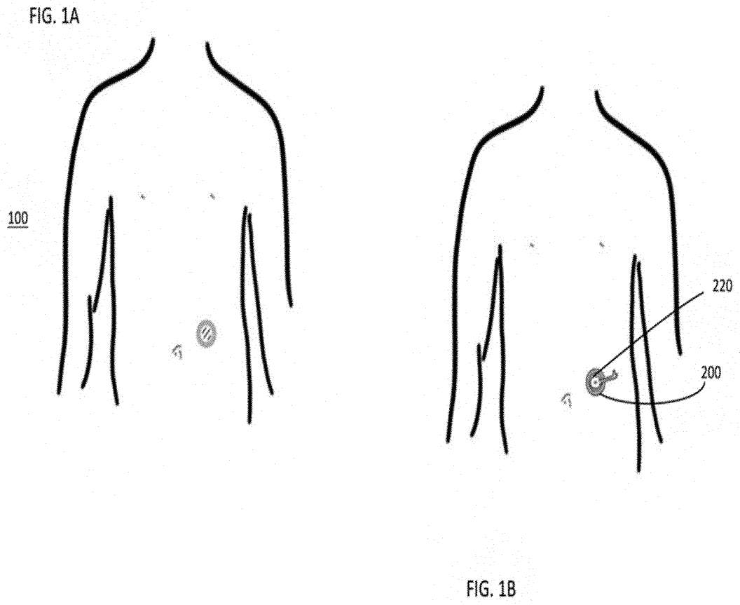

Turning now to FIG. 1A, a first view of the device in-situ within a patient consistent with certain embodiments of the present invention is shown. Patient 100 is shown with surgically inserted Stoma Liner Grommet 200 placed within the Abdominal Wall 104 of Patient 100. Stoma Liner Grommet 200 creates a channel through which medically necessary or advisable materiel may be painlessly introduced into or removed from one or more portion of the GI tract of Patient 100. The central portion of Stoma Liner Grommet 200, which acts as a GI tract access channel, is denoted herein by diagonal line shading.

Turning now to FIG. 1B, a second view of the device in-situ within a patient consistent with certain embodiments of the present invention is shown. Patient 100 is shown with surgically inserted Stoma Liner Grommet 200 into which has been inserted a Plug 220. Plug 220 serves to provide selective hygienic access to the central portion of the Stoma Liner Grommet 200.

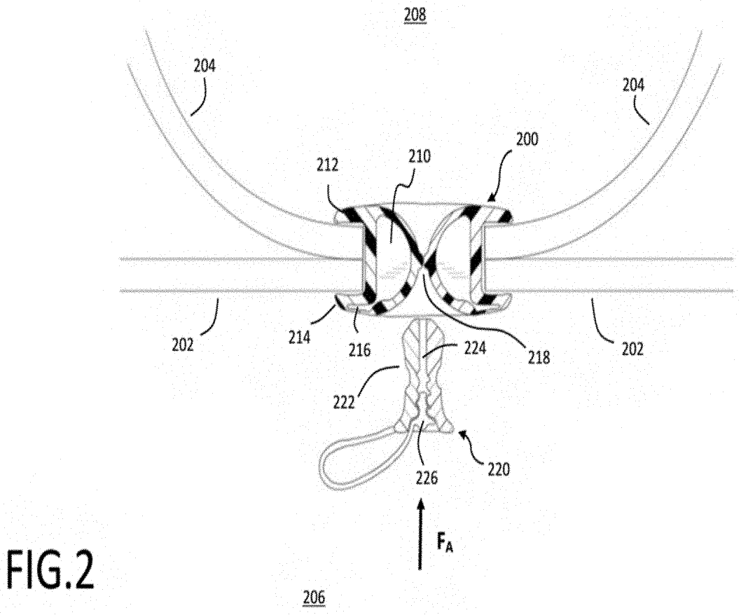

Turning now to FIG. 2, a first cross-sectional view of the in-situ device consistent with certain embodiments of the present invention is shown. Stoma Liner Grommet 200 bisects and connects the tissues forming a patient's Abdominal Wall Cross Section 202 and patient's Stomach Wall Cross Section 204. Stoma Liner Grommet 200 is roughly torus-shaped and occupies a position between the patient's Stomach Interior 208 and the patient's Ambient Surroundings 206. Stoma Liner Grommet 200 has an adjustably inflatable interior Bladder 210, the inflation or deflation of which may be affected by the introduction or removal of saline or any other medically suitable fluid medium. Inflation or deflation of Bladder 210 causes torsional change to affect the directional aspect of External Pinch Point 214 such that Abdominal Wall Cross Section 202 and Stomach Wall Cross Section 204 are pinched between External Pinch Point 214 and Internal Pinch Point 212. Precision application of such torsional change is affected through incorporation of Fluid Extension Channel 216 from the Bladder 210 into the exterior and/or the interior portion of the Stoma Liner Grommet 200. Stoma Liner Grommet 200 is roughly symmetrically disposed around a Main Channel 218. Main Channel 218 serves as an adjustable transit point for medically necessary materiel transport between the Ambient Surroundings 206 and the Stomach Interior 208. A Plug 220 may be inserted into the Main Channel 218 through application of a linear push force. Plug 220 is characterized by a Solid Body 222 that is roughly symmetrically disposed around a Plug Channel 224, the exterior opening of Plug Channel 224 being adjustably occluded by Plug Cap 226. Plug Cap 226 may be seated within Plug Channel 224 through application of a liner push force FA. However, removal of Plug Cap 226 may be affected only through application of both a liner pull force and a torsional force in combination. In a non-limiting example, the torsional force may consist of turning the Plug Cap 226 a quarter turn in a predetermined direction prior to applying the linear force to effect the removal of the Plug Cap 226. The Plug Cap 226 may be substituted within Plug Channel 224 by feeding and/or maintenance tubes or devices (not shown) requiring similar methods of seating and removal.

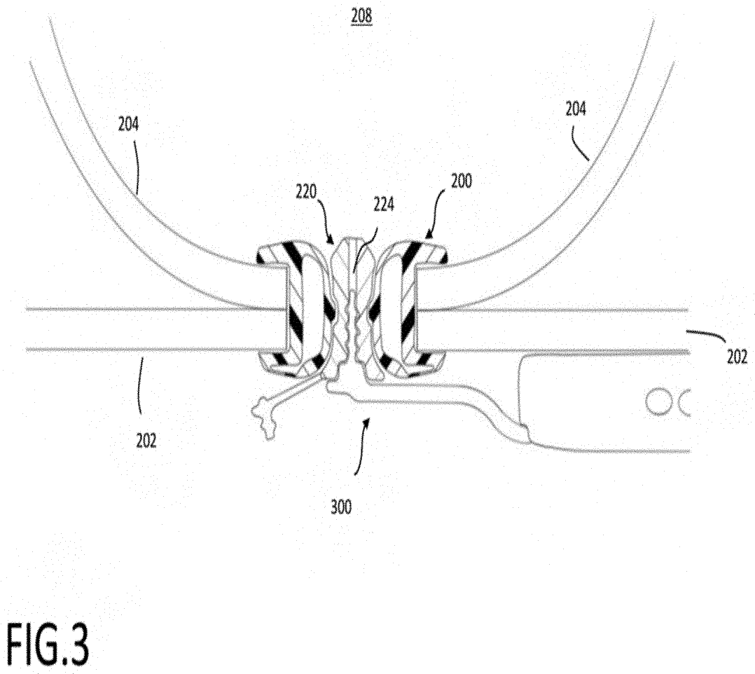

Turning now to FIG. 3, a second cross-sectional view of the in-situ device consistent with certain embodiments of the present invention is shown. Enteral Feeding Device 300 is shown as having replaced the Plug Cap 226 shown in FIG. 2. Enteral Feeding Device 300 has been attached to Plug 220 through application of a push force. One or more Pumps (not shown), which may consist of immersion pumps or other pumps suitable to the application, are activated to introduce fluid materiel through Plug Channel 224 and into Stomach Interior 208, passing Abdominal Wall Cross Section 202 and Stomach Wall Cross Section 204.

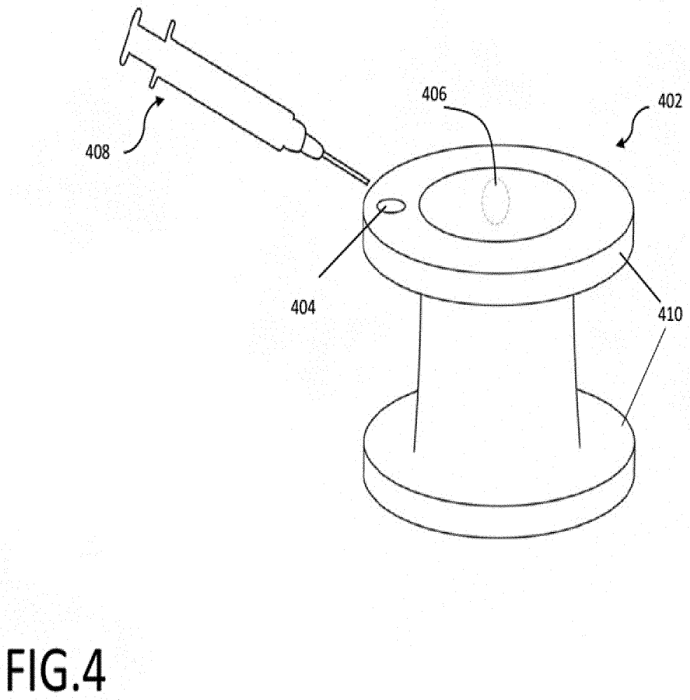

Turning now to FIG. 4, a stylized orthogonal view of a stand-alone Stoma Liner Grommet consistent with certain embodiments of the present invention is shown. Stoma Liner Grommet 402 represents the cross-cutaneous portion of FIG. 2 when not in-situ within a patient. In an embodiment, Specialized Connection Point 404 receives saline solution from Syringe 408 to inflate Bladders 410. Bladders 410 inflated with saline grip the access device. Specialized Connection Point 404 may be characterized by a specialized syringe connection, may be made of a self-healing silicon material that would allow for the bladder surface to be punctured with a syringe-needle, or may use a similar method to provide cross-membranous fluid delivery. Sensor 406 may be designed to detect one feed characteristic at a time, or may be designed to detect more than one feed characteristic simultaneously. By way of non-limiting example, Sensor 406 may incorporate an optical sensor “eye” which would be flush or near-flush with the interior surface of the portion of the Stoma Liner Grommet 402 that penetrates through the abdominal wall and which detects optical characteristics of the feed material. Sensor 406 may also incorporate a pressure sensor included beneath the surface of the same portion of Stoma Liner Grommet 402. In an embodiment, low-power Bluetooth-enabled technology sends sensor readings to a control device (not shown).

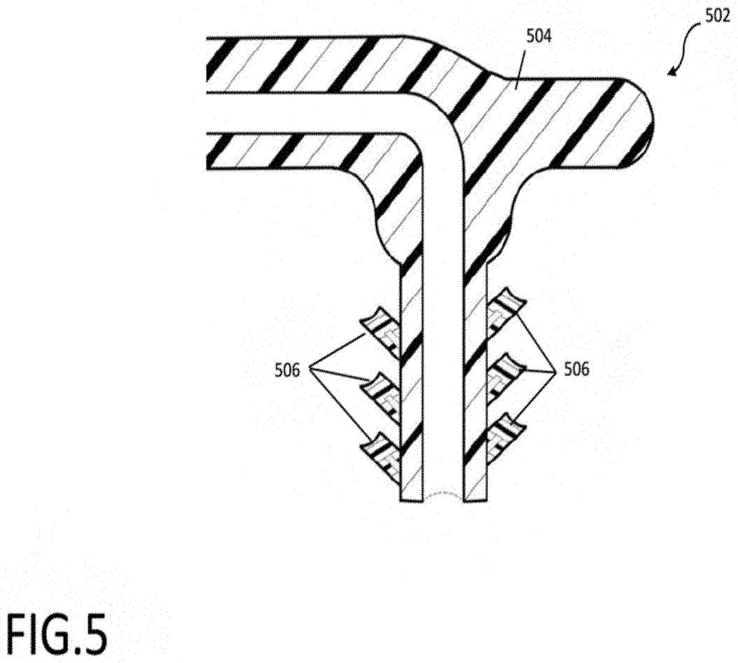

Turning now to FIG. 5, a cross-sectional view of Safety Release Points that permit the device to disassemble under a certain threshold force consistent with certain embodiments of the present invention is shown. One half of bilaterally symmetrical Connector 502 is shown in cross-section. Connector 502 is composed of Main Body 504 and Threads 506. Threads 506 are constructed of a silicone-composite material that coats a short length of rigid material. This rigid material may be, by way of non-limiting example, plastic, metal, or composite. Threads 506 are oriented in a geometric fashion resembling an upside-down Christmas tree. Threads 506 experience a certain amount of deformation when inserted with a push force into a cylindrical cavity such as the Stoma Grommet Liner of the instant innovation (not shown). The rigidity and geometry of Threads 506 hinder removal of Connector 502 when Connector 502 is subjected to an oppositional pull force, but such hinderance may be overcome by the simultaneous application of a torsional force to the removal of Connector 502. Notwithstanding the designed hinderance, upon application of a threshold force (in a non-limiting example, between 15 Newtons and 30 Newtons) the hinderance will intentionally fail to prevent removal, thereby releasing Connector 502 before causing undue dislodgment of an access device (not shown) or undue discomfort to a patient.

While certain illustrative embodiments have been described, it is evident that many alternatives, modifications, permutations and variations will become apparent to those skilled in the art in light of the foregoing description.

We claim:

1. An enteral nutrition gastronomy device comprising:
an implantable grommet operative to penetrate and connect to tissues forming a human's abdominal wall and gastrointestinal wall, the grommet being symmetrically disposed around a central channel;
a bilaterally symmetrical connector capable of quick connection and quick disconnection to said central channel; and
the grommet and bilaterally symmetrical connector operative to maintain a cross-cutaneous delivery channel for enteral fluid delivery.

2. The device of claim 1, where the grommet is roughly torus-shaped.

3. The device of claim 1, where said quick connection is affected through application of a linear push force.

4. The device of claim 3, where said quick connection fails upon application of a pull force exceeding a range of 15-30 Newtons.

5. The device of claim 1, where said quick disconnection is affected though application of a combination of a linear pull force and at least one torsional force.

6. The device of claim 1, where said grommet connects to said tissues by application of oppositional pinching forces.

7. The device of claim 6, where the application of oppositional pinching forces is by inflation and/or deflation of one or more bladders.

8. The device of claim 1, where positioning of the implantable grommet is semi-permanent.
